(19) United States
(12) Patent Application Publication
(10) Pub. No.: US 2015/0352481 A1
(43) Pub. Date: Dec. 10, 2015

(54) APPARATUS AND METHOD FOR HYDROGEN RECOVERY IN AN ANDRUSSOW PROCESS

(71) Applicant: INVISTA TECHNOLOGIES S.A R.L., Wilmington (DE)

(72) Inventors: Stewart FORSYTH, Wilmington, DE (US); Aiguo LIU, Elk Grove, IL (US); Martin J. RENNER, Hallettsville, TX (US); Brent J. STAHLMAN, Victoria, TX (US)

(73) Assignee: INVISTA NORTH AMERICA S.A R.L., Wilmington (DE)

(21) Appl. No.: 14/742,026

(22) PCT Filed: Dec. 12, 2013
(86) PCT No.: PCT/US2013/074616

§ 371 Date: Jun. 17, 2015

Related U.S. Application Data
(60) Provisional application No. 61/738,685, filed on Dec. 18, 2012.

(51) Int. Cl. B01D 53/047

(52) U.S. Cl. CPC B01D 53/047; B01D 2253/106; B01D 2253/102; B01D 2253/108; B01D 2253/116; B01D 2256/16; B01D 2257/406; B01D 2257/408

(57) ABSTRACT

A method and a system for recovering hydrogen from a process for making hydrogen cyanide are described herein. In the method, hydrogen is recovered from a gaseous waste stream of an Andrussow process. The method comprises the following steps: (a) adjusting a reaction mixture comprising methane, ammonia and oxygen to provide the reaction mixture with sufficient oxygen to generate a gaseous waste stream that has at least 40% hydrogen after removal of ammonia and recovery of hydrogen cyanide; and (b) removing components from the gaseous waste stream to generate recovered hydrogen.

### CROSS-REFERENCE TO RELATED APPLICATION

This application claims the benefit of priority to U.S. Provisional Patent Application Ser. No. 61/738,685 entitled “APPARATUS AND METHOD FOR HYDROGEN RECOVERY IN AN ANDRUSSOW PROCESS,” filed Dec. 18, 2012, the disclosure of which is incorporated herein in its entirety by reference.

### TECHNICAL FIELD

The present disclosure is directed to recovery of hydrogen for the Andrussow process for the production of hydrogen cyanide (HCN) from methane, ammonia, and oxygen.

### BACKGROUND

An Andrussow reaction proceeds in the presence of a suitable catalyst, such as a Pt-containing catalyst, as follows:

2NH₃+2CH₄+3O₂→2HCN+6H₂O

Reactant gas feedstreams including a gaseous ammonia feedstream, a gaseous methane feedstream and a gaseous oxygen feedstream react in the presence of a platinum-containing catalyst to form hydrogen cyanide (HCN) and water in a product stream. However, the reaction does not proceed with 100% efficiency, and the product stream contains a number of other compounds in addition to hydrogen cyanide, such as unreacted ammonia, unreacted methane, carbon dioxide, carbon monoxide, water, nitrogen, hydrogen, and a variety of organonitriles.

When substantially pure oxygen, rather than air, is used as the source of oxygen for the Andrussow process, the waste stream can contain a substantial proportion of hydrogen. Disposal of such a waste stream by flaring is wasteful.

Various aspects of HCN production are described in the following articles: Eric. L. Crump, U.S. Environmental Protection Agency, Office of Air Quality Planning and Standards, Economic Impact Analysis For the Proposed Cyanide Manufacturing NESHAP (May 2000), available online at http://nepis.epa.gov/Exe/ZyPDF.cgi?Dockey=P100AHG1.PDF, is directed toward the manufacture, end uses, and economic impacts of HCN; N. V. Trusov, Effect of Sulfur Compounds and Higher Homologues of Methane on Hydrogen Cyanide Production by the Andrussow Method, Rus. J. of Applied Chemistry, Vol. 74, No. 10, pp. 1693-97 (2001), is directed toward the effects of unavoidable components of natural gas, such as sulfur and higher homologues of methane, on the production of HCN by the Andrussow process; Clean Development Mechanism (CDM) Executive Board, United Nations Framework Convention on Climate Change (UNFCCC), Clean Development Mechanism Project Design Document Form (CDM PDD), Ver. 3, (Jul. 28, 2006), available online at http://cdm.unfccc.int/Reference/PDDs_Forms/PDDs/PDD_form04_v03_{—}2.pdf, is directed toward the production of HCN by the Andrussow process; and Gary R. Maxwell et al., Assuring process safety in the transfer of hydrogen cyanide manufacturing technology, J. of Hazardous Materials, Vol. 142, pp. 677-84 (2007), is directed toward the safe production of HCN.

### SUMMARY

The problem of wasting hydrogen in an Andrussow process is solved or improved by recovering the hydrogen from the waste gases rather than, for example, flaring it. Hydrogen recovery from the waste stream of an Andrussow process can, for example, provide substantially all the hydrogen needs of a hexamethylene diamine production facility. Hence, hydrogen recovery can obviate the need for a steam reformer that might otherwise be needed for hydrogen production from purchased hydrocarbon fuels (e.g., natural gas, propane, gas, oil, and the like). Hydrogen recovery from an Andrussow process can therefore reduce carbon emissions into the atmosphere and provide substantial cost savings to HCN manufacturers.

However, not all Andrussow facilities can or should be adapted for hydrogen recovery. To make hydrogen recovery economically attractive the Andrussow process cannot be performed with air as its gaseous oxygen feedstream. Instead, hydrogen recovery is only economically attractive when an oxygen-enriched or oxygen Andrussow process employed. Although the waste stream can contain substantial amounts of hydrogen when an oxygen-enriched or oxygen feedstream is used as an oxygen source for an Andrussow process, use of such enriched oxygen sources can give rise to a number of problems.

Some problems of using oxygen-enriched or oxygen feedstreams are readily understood. For example, oxygen-enriched and substantially pure oxygen feedstreams are more expensive than air. Concentrated oxygen sources and waste streams that contain high levels of hydrogen are susceptible to ignition, particularly at the high temperatures employed for Andrussow processes (about 850° C. to about 2,500° C., or about 1000° C. to about 1,500° C.). An oxygen-enriched or oxygen Andrussow process may require additional safety precautions and controls than an Andrussow process that employs air as its gaseous oxygen feedstream. Hydrogen is highly flammable and will burn in air at wide ranges of concentrations, for example, between 4% and 75% by volume. Equipment design, equipment maintenance, and operating conditions that are not generally used or needed in an air Andrussow process can be employed to address problems raised when combining hydrogen recovery with an oxygen-enriched or oxygen Andrussow process.

Very few oxygen-enriched or oxygen Andrussow manufacturing facilities exist. In addition to the more readily apparent concerns associated with oxygen-enriched or oxygen Andrussow manufacturing facilities such as those described above, there are a multitude of additional problems that are not readily or widely understood.

For example, an oxygen-enriched or oxygen Andrussow process is more sensitive to variations in concentration of reactants than in an Andrussow process that employs air. Variations in concentration or flow rate of reactants in an oxygen-enriched or oxygen Andrussow process can cause larger changes in the efficiency of the process than are observed in an air Andrussow process. An oxygen-enriched or oxygen Andrussow process is more sensitive to changes in heat value of the feed gas; small variations in the composition of the feedstream can cause greater temperature fluctuations in the reactor than would be observed for similar feedstream compositions in an air Andrussow process. Local variations in the concentration of reactants contacting the catalyst can cause temperature variations in the catalyst bed, such as hot spots, which can reduce the life of the catalyst as compared to an air Andrussow process. An oxygen-enriched or oxygen Andrussow process can also require additional safety control features, for example, to avoid problems of ignition or detonation. The presence of about 78% nitrogen in air serves to dilute the gas mixture in an air Andrussow process, which not only reduces the dangers of ignition but also reduces the production of by-products and the need for heightened control of the reaction.

Heat transfer from the effluent of an oxygen-enriched or oxygen Andrussow process poses more problems than observed for an air Andrussow process. The effluent from an oxygen-enriched or oxygen Andrussow process is more concentrated than for an air Andrussow process. While cooling such a concentrated effluent is best done quickly to stop reactants from forming by-products, the effluent should not be cooled to the point of HCN condensation because the HCN has a greater propensity for polymerization when condensed. HCN polymerization can lead to explosions and safety are used, especially in an oxygen-enriched or oxygen Andrussow process, to control and avoid such problems.

An oxygen-enriched or oxygen Andrussow process tends to proceed in a more concentrated fashion than an air Andrussow process. As such, an oxygen-enriched or oxygen Andrussow process tends to generate a higher concentration of all products, including by-products. Hence, the reactor and associated equipment for an oxygen-enriched or oxygen Andrussow process is more susceptible to the build-up of impurities in the system that can more easily be flushed out of the equipment employed in an air Andrussow process. The greater rate of by-product build-up can lead to increased rates of corrosion as well as more frequent shut down and maintenance of various parts of the process. Equipment that can be significantly affected by by-product build-up, corrosion and related problems includes, for example, the reactor(s), the ammonia recovery system(s), and the HCN recovery system(s).

Although the equipment needed for production of an equivalent amount of HCN can be more compact (smaller) for an oxygen-enriched or oxygen Andrussow process than for an air Andrussow process, many manufacturers would choose to operate an air Andrussow process, where hydrogen recovery is not economically worthwhile, to avoid the problems associated with an oxygen-enriched or oxygen Andrussow process. The problems associated with combining an oxygen-enriched or oxygen Andrussow process with hydrogen recovery are not well described in the current literature and the difficulties are of sufficient magnitude that most manufacturers would not attempt such a combination.

However, the benefits can be surprisingly large. For example, with efficient hydrogen recovery from an oxygen-enriched or oxygen Andrussow process the costs of adiponitrile production can be cut by 10%, or 20%, or 30%, or 40%, or more.

The benefits of solving these and other problems are realized by the methods and systems described herein.

A method of recovering hydrogen from a gaseous waste stream of an Andrussow process is described herein that includes:

(a) adjusting a reaction mixture comprising methane, ammonia and oxygen to provide the reaction mixture with sufficient oxygen to generate a gaseous waste stream that has at least 40% hydrogen after removal of ammonia and recovery of hydrogen cyanide; and

(b) removing components from the gaseous waste stream to generate recovered hydrogen.

A system is described herein that includes:

(a) a reactor configured for producing hydrogen cyanide from a reaction mixture comprising methane, ammonia and oxygen in the presence of a platinum catalyst, wherein the reactor produces a gaseous product stream comprising the hydrogen cyanide; and

(b) a hydrogen recovery system configured to recover hydrogen from a gaseous waste stream produced after ammonia and the hydrogen cyanide have been substantially removed from the gaseous product stream.

The reactor of the system can also be configured to supply the reaction mixture with sufficient oxygen to generate a gaseous waste stream that has at least 40% hydrogen after removal of ammonia and recovery of hydrogen cyanide.

### DESCRIPTION OF THE DRAWINGS

FIG. 1 illustrates an exemplary Andrussow system that includes a hydrogen recovery unit.

FIG. 2 illustrates an exemplary hydrogen recovery system that can be operably linked to an Andrussow manufacturing system.

### DETAILED DESCRIPTION

The invention safely solves the problems of wasteful loss of hydrogen from an oxygen-enriched or oxygen Andrussow process product stream by use of the hydrogen recovery methods and systems described herein. Significant hydrogen can be present in a gaseous waste stream remaining after hydrogen cyanide isolation from an oxygen-enriched or oxygen Andrussow reaction product stream.

### Andrussow Processes

During an Andrussow process, reactant gas feedstreams including a gaseous ammonia feedstream, a gaseous methane feedstream and a gaseous oxygen feedstream react to form a product stream that contains hydrogen cyanide and water. This reaction is described by Andrussow in U.S. Pat. No. 1,934,838 issued Nov. 14, 1933, and by Jenks in U.S. Pat. No. 3,164,945.

Andrussow processes can be performed using a variety of sources for the gaseous oxygen feedstream. For example, the gaseous oxygen feedstream can be pure oxygen, mixtures of oxygen with inert gases, as well as mixtures of air and oxygen. In general, a greater percentage of oxygen in the gaseous oxygen feedstream will give rise to a greater percentage of hydrogen in the gaseous waste stream. For example, an Andrussow process that employs a gaseous oxygen feedstream that is substantially pure oxygen can yield a gaseous waste stream with as much as 70-80% hydrogen. However, an Andrussow process that employs air as its gaseous oxygen feedstream has substantially less hydrogen in its waste stream, for example, as little as 15-18%. Hence, hydrogen recovery from an Andrussow process that uses oxygen-enriched or substantially pure oxygen gas as the oxygen-containing feedstream may be more economically attractive than such recovery from an Andrussow process that uses air as its gaseous oxygen feedstream. For example, hydrogen recovery may not advantageously be performed with an air Andrussow process.

As used herein, an air Andrussow process uses air as the oxygen-containing feedstream, having approximately 20.95 mol % oxygen. An oxygen-enriched Andrussow process uses an oxygen-containing feed stream having about 21 mol % oxygen to about 26%, 27%, 28%, 29%, or to about 30 mol % oxygen, such as about 22 mol % oxygen, 23%, 24%, or about 25 mol % oxygen.

An oxygen Andrussow process uses an oxygen-containing feed stream having about 26 mol % oxygen, 27%, 28%, 29%, or about 30 mol % oxygen to about 100 mol % oxygen. An oxygen Andrussow process can also use an oxygen-containing feed stream having about 35 mol % oxygen, 40%, 45%, 50%, 55%, 60%, 65%, 70%, 75%, 80%, 85%, 90%, 95%, 98%, 99%, 99.9%, 99.99% or about 100 mol % oxygen.

An oxygen-containing feedstock can have some organic material, but only small amounts. For example, an oxygen feedstock can have less than 2.0% organic material, or less than 1.0% organic material, or less than 0.5% organic material, or less than 0.1% organic material. Such organic materials can induce carbon dioxide, carbon monoxide, alkanes (other than methane), and high hydrocarbons. Reduced organic material in the oxygen-containing feedstream reduces by-product formation and carbon build-up in the Andrussow reaction and product processing equipment.

In various examples, the oxygen-containing feedstream in an oxygen-enriched Andrussow process, or in an oxygen Andrussow process with an oxygen-containing feedstream having less than 100 mol % oxygen, can be generated by mixing air with oxygen, by mixing oxygen with any suitable gas or combination of gases, or by removing one or more gases from an oxygen-containing gas composition such as air.

The methane feedstream can include some impurities, for example, a low percentage of alkanes with 1-4 carbon atoms, carbon dioxide, nitrogen, oxygen and combinations thereof. For example, natural gas can be a source of methane, but the amount and type of impurities in natural gas can vary. Use of methane feedstreams with significant percentages of impurities can lead to carbon build up on the platinum catalyst. Even low percentages of higher hydrocarbons, for example mixed with about 96% vol/vol methane, can lead to some carbon build up, which reduces HCN yields and, if continued, leads to physical disintegration of catalyst structures. Although minor carbon build-up occurs with pure methane feedstreams, such carbon build-up is relatively slow, yields and conversions decrease only moderately, and the catalyst can last for several months. For example, the methane feedstream should not contain more than about 2% alkanes, and/or not more than about 2% carbon dioxide, and/or not more than 2% of hydrogen sulfide, and/or not more than about 3% nitrogen, and/or not more than about 2% carbon dioxide. Impurities can be removed from methane feedstocks by available procedures. Reduction of impurities in methane can reduce by-product formation and impurities that may complicate hydrogen recovery.

Substantially pure methane is generally available and can be used in an oxygen-enriched or oxygen Andrussow. Such substantially pure methane can be 95% methane, or 98% methane, or 99% methane. Substantially pure methane can have less than 100 ppm impurities, or less than 10 ppm impurities, or even 1 ppm or less impurities.

Ammonia feedstocks can contain some moisture and/or trace amounts air or oxygen. Such trace amounts include up to but not more than 2% by volume of the total gas composition. However, significant percentages of oxygen and/or water can cause problems such as formation of ammonia hydroxide that can be corrosive to parts of the reactor or the dehumidifier. Thus, if high levels of oxygen are present in a feedstock, the ammonia feedstock can be treated to reduce the total content of oxygen to 1% by volume or less. In the case of water, the ammonia feedstream can contain up to 5% by volume steam, or up to 2% by volume steam mixed with the ammonia. The ammonia feedstream can also be 90% ammonia, or 95% ammonia, or 99% ammonia, or 100% ammonia.

The synthesis of hydrogen cyanide by the Andrussow method (see, for example, Ullmann's Encyclopedia of Industrial Chemistry, Volume 8, VCH Verlagsgesellschaft, Weinheim, 1987, pp. 161-162) can be carried out in the vapor phase over a catalyst that comprises platinum or platinum alloys, or other metals. Catalysts suitable for carrying out the Andrussow process were discovered and have been described in the original Andrussow patent, published as U.S. Pat. No. 1,934,838, and elsewhere. In Andrussow's original work, he disclosed that catalysts can be chosen from oxidation catalysts that are infusible (solid) at the working temperature of around 1000° C. For example, Andrussow describes catalysts that can include platinum, iridium, rhodium, palladium, osmium, gold or silver as catalytically active metals either in pure form or as alloys. He also noted that certain base metals, such as rare earth metals, thorium, uranium, and others, could also be used, such as in the form of infusible oxides or phosphates, and that catalysts could either be formed into nets (screens), or deposited on thermally-resistant solid supports such as silica or alumina.

In subsequent development work, platinum-containing catalysts have been selected due to their efficacy and to the heat resistance of the metal even in gauze or net form. For example, a platinum-rhodium alloy can be used as the catalyst, which can be in the form of a metal gauze or screen such as a woven or knitted gauze sheet, or can be disposed on a support structure. In an example, the woven or knitted gauze sheet can form a mesh-like structure having a size from 20-80 mesh, e.g., having openings with a size from about 0.18 mm to about 0.85 mm. A catalyst can comprise from about 85 wt % to about 95 wt % Pt and from about 5 wt % to about 15 wt % Rh, such as 85/15 Pt/Rh, 90/10, or 95/5 Pt/Rh. A platinum-rhodium catalyst can also comprise small amounts of metal impurities, such as iron (Fe), palladium (Pd), iridium (Ir), ruthenium (Ru), and other metals. The impurity metals can be present in trace amounts, such as about 10 ppm or less.

Further information on the Andrussow method is described in German Patent 549,055. In one example, a catalyst comprising a plurality of fine-mesh gauzes of Pt with 10% rhodium disposed in series is used at temperatures of about 800 to about 2,500° C., 1,000 to 1,500° C., or about 980 to 1,050° C. For example, the catalyst can be a commercially-available catalyst, such as a Pt—Rh catalyst gauze available from Johnson Matthey Plc, London, UK, or a Pt—Rh catalyst gauze available from Heraeus Precious Metals GmbH & Co., Hanau, Germany.

A product stream emerging from an Andrussow reactor contains a number of compounds in addition to hydrogen cyanide, such as unreacted ammonia, unreacted methane, carbon dioxide, carbon monoxide, water, nitrogen, hydrogen, and a variety of organonitriles.

To purify the hydrogen cyanide, the ammonia in the product stream is typically removed first, followed by hydrogen cyanide isolation. The remaining gaseous waste stream contains hydrogen that can be isolated using the methods, apparatuses and systems described herein.

### Ammonia Removal/Recycling

An exit gas from an Andrussow reactor is referred to herein as the product stream. Such a product stream contains HCN and ammonia, amongst other compounds and gases such as hydrogen, unreacted methane, carbon dioxide, carbon monoxide, water, nitrogen, a variety of organonitriles, and other compounds. To remove ammonia, which can be recycled back into the Andrussow reaction, the product stream can be fed into an ammonia absorber unit. Such an ammonia absorber unit can contain a solution that absorbs ammonia, for example, an ammonium phosphate solution, a phosphoric acid solution or a sulfuric acid solution.

One example of an ammonium phosphate solution that can be used includes compounds having the formula:

(NH₄)ₙH₃₋ₙPO₄

where n is number of about 0-3. The molar ratio of NH₃ to H₃PO₄, together with the temperature, and the concentration of other components in the product stream (e.g., water), can impact the capacity of the solution for absorbing ammonia. In general, a solution where n is lower than 1.5 has reduced ammonia and can absorb more ammonia than a solution in which n is greater than 1.5, which has higher amounts of ammonia. The gaseous stream leaving the ammonia absorber is referred to as a semi-purified product stream and can be a source of hydrogen.

Upon absorption of ammonia, an ammonia-rich ammonium phosphate solution is formed. Such an ammonia-rich ammonium phosphate solution can have, for example, an ammonium ion to phosphate ion ratio higher than 1.5. The ammonia-rich ammonium phosphate solution can be fed into an ammonia stripper unit. The ammonia stripper unit can be a distillation column with multiple trays. Heat can be supplied through a reboiler section of the distillation column to force desorption of ammonia from the rich ammonium phosphate solution. Rich ammonium phosphate solution can be converted back to lean ammonium phosphate solution by this process.

A stream of ammonia and water vapor can leave the top of the ammonia stripper unit. The ammonia can be recycled or reused in the Andrussow reaction. A stream of lean ammonium phosphate solution can flow out of the ammonia stripper unit, or be pumped into a cooling unit to produce a stream of cooled lean ammonium phosphate solution.

After removal, only small amounts of ammonia typically remain in the semi-purified product stream that contains HCN. For example, less than about 5% vol/vol, or less than about 4% vol/vol, or less than about 3% vol/vol, or less than about 2% vol/vol, or less than about 1% vol/vol, or less than about 0.5% vol/vol, or less than about 0.1% vol/vol residual ammonia typically remains in the semi-purified product stream that contains HCN. In some cases, ammonia in the semi-purified product cannot be detected by typical procedures such as by use of Nessler's solution (yellow color when ammonia is present) or absorption into hydrochloric acid or sulfuric acid.

### HCN Recovery

HCN can be recovered from the semi-purified product stream (e.g., after ammonia removal) by a variety of procedures. For example, after removal of ammonia, the semi-purified product stream can be sent through an HCN absorber unit where cold water is added to entrain the HCN. The HCN-water mixture can then be sent to a cyanide stripper where excess waste is removed from the liquid. In addition, the HCN-water mixture may also be sent through a fractionator to concentrate the HCN before the product is stored in tanks or used directly for synthesis of other compounds.

Hydrogen is recovered from the gaseous waste stream remaining after HCN removal. Removal of HCN is typically substantially complete not only so that valuable HCN is not lost to the waste stream, but also for health and environmental concerns.

### Hydrogen Recovery

After removal of ammonia and hydrogen cyanide from an Andrussow product stream, a gaseous waste product stream remains that contains a variety of gases including hydrogen, unreacted methane, carbon dioxide, carbon monoxide, water, nitrogen, a variety of organonitriles, and trace amounts of HCN. The amounts of these gases in the gaseous waste product stream can vary depending upon Andrussow reaction conditions. Variables that can affect the composition of the gaseous waste product stream include the amount of oxygen in the Andrussow reaction, the ratios of methane to ammonia, the temperature of the reactor, the catalyst effectiveness, flow rates into and through an Andrussow reactor, and the like.

For example, when pure oxygen is used as a reactant in an Andrussow process and reaction conditions generally optimized, up to about 75% (vol/vol) hydrogen can be present in the waste product stream, but when air is employed as a source of oxygen for the Andrussow reaction, only about 1.5% (vol/vol) hydrogen may be present in the waste product stream. Hence, the gaseous oxygen-containing feedstream to an Andrussow reactor can contain a wide percentage of oxygen relative to the other gases, and still provide significant hydrogen in the gaseous waste stream.

Hydrogen can therefore profitably be obtained not only from Andrussow processes that use 100% oxygen as an oxygen-containing feedstream, but also from Andrussow reactions that employ less than 100% oxygen as an oxygen-containing feedstream. For example, hydrogen can be obtained from Andrussow reactions that employ mixtures of oxygen with other gases (e.g., nitrogen or argon), or from Andrussow reactions that employ air enriched with oxygen. When oxygen is mixed with other gases, those other gases generally include only low levels of carbon-containing compounds (other than methane). Carbon-containing compounds such as alkanes and hydrocarbons can lead to carbon build up in the Andrussow reactor equipment and catalyst if present in significant amounts. Therefore, carbon-containing compounds are avoided in the oxygen-containing feedstream.

The methods, apparatuses and systems described herein can be particularly useful when an Andrussow process is adapted to employ an oxygen-containing feedstream that contains somewhat higher levels of oxygen than air. For example, such an oxygen-containing feedstream can contain at least about 25% oxygen, at least about 30% oxygen, at least about 40% oxygen, at least about 50% oxygen, at least about 60% oxygen, at least about 70% oxygen, at least about 80% oxygen, at least about 90% oxygen, at least about 95% oxygen, at least about 98% oxygen, at least 99% oxygen, at least 99.9% oxygen, or at least 99.99% oxygen. Substantially pure oxygen can also be employed as the oxygen-containing feedstream.

The efficiency of an Andrussow process can vary depending upon factors such as the purity of the ammonia and methane feedstreams, the effectiveness and/or age of the catalyst bed, the temperature of the Andrussow reaction, the shape and mixing properties of the reactor, the care employed in adjusting and maintaining an optimal balance of reactant feedstreams, and combinations thereof. Thus, a method can be used for assessing what proportion of oxygen in an oxygen-containing feedstream is sufficient to make hydrogen recovery economically attractive. The method can include: varying the percent volume of oxygen in the oxygen-containing feedstream from about 35% to about 100% during a series of separate Andrussow processes (e.g., run in parallel or in series) and determining the percent hydrogen in a gaseous waste stream from each Andrussow process; and identifying the percent volume of oxygen (the X percent oxygen volume) that yields about 40% hydrogen in the waste gas stream. Such an X percent oxygen volume is the proportion of oxygen in an oxygen-containing feedstream that is sufficient to make hydrogen recovery economically attractive.

The gaseous waste stream remaining after ammonia and HCN removal can contain a variety of compounds such as unreacted ammonia, unreacted methane, carbon dioxide, water, carbon monoxide, water, nitrogen, hydrogen, and organonitriles. The gaseous waste stream can advantageously contain lower amounts of nitrogen than are present in air. For example, the gaseous waste stream can contain less than about 60% nitrogen, less than about 50% nitrogen, less than about 40% nitrogen, less than about 30% nitrogen, less than about 20%, or less than about 10%.

The gaseous waste stream remaining after ammonia and HCN removal can be treated in a variety of ways to generate recovered hydrogen with the desired purity. For example, components can be removed from the gaseous waste stream by methods involving pressure swing adsorption (adsorption), selective membranes, amine scrubbing (absorption), cryogenic purification, a water gas shift reaction, or a combination thereof. The water content in the gaseous waste stream can be reduced by passage of the gaseous waste stream through a dehumidifying unit, for example, a condenser. Removal of water can occur during or after other purification steps. However, it may be more efficient to remove water before passage of the gaseous waste stream through some types of adsorption, absorption and membrane-containing units.

Pressure swing adsorption (PSA) involves separation of selected gas species from a mixture of gases under pressure according to the species' molecular characteristics and affinity for an adsorbent material. Pressure swing adsorption can operate at near-ambient temperatures and thus differs from cryogenic distillation techniques of gas separation. Adsorptive materials (e.g., zeolites) can be used as a molecular sieve during pressure swing adsorption, and depending upon the adsorption materials, the impurities or the target gas species are absorbed, typically at high pressure. The process can then swing to low pressure to desorb the impurities or the target gas species from the adsorbent material. Thus, pressure swing adsorption can be utilized to separate a feed gas comprising more strongly adsorbable components and less strongly adsorbable components into a non-adsorbed stream enriched in the less strongly adsorbable components and an adsorbed stream enriched in the more strongly adsorbable components.

The PSA adsorptive materials can be in the form of membranes, particles, crystals, pellets, beads, nanotubes, fibers, meshes, discs, matrices, mixed matrix membranes, and combinations thereof. Such materials can be placed into one or more columns, beds, tubes, or other containers within a pressure swing adsorption unit.

The PSA adsorptive materials can include activated carbon, graphite, silica, alumina, zeolites, metals (e.g., platinum or palladium), and combinations thereof. Hydrophilic and polar compounds (such as oxygen-containing compounds) can, for example, adsorb to silica gels and zeolites. Hydrophobic compounds (such as alkanes and other carbon-rich compounds) can, for example, adsorb to activated carbon and graphite. Polymer based compounds can, for example, adsorbed by porous polymer matrices that have polar or non-polar functional groups adapted to adsorb polymers that can bind to such functional groups.

Silica can be used for drying (water removal) and adsorption of heavy, polar hydrocarbons from gaseous waste stream. Silica is a chemically inert, nontoxic, polar and dimensionally stable (<400° C. or 750° F.) amorphous form of SiO₂. It can be prepared by the reaction between sodium silicate and acetic acid, followed by a series of after-treatment processes such as aging, pickling, washing and drying. Silica used as an adsorptive material can have various pore size distributions, and the pore size can be adapted to help exclude or include molecules of selected sizes.

Zeolites can also be used for drying (water removal) of the gaseous waste stream as well as for removing carbon dioxide and carbon monoxide. Zeolites can be made by mixing sodium silicate, alumina trihydrate and sodium hydroxide, and allowing the mixture to gel and/or crystallize. After washing the crystals, they can be subjected to cationic exchange to replace the sodium with other cations such as calcium, potassium or some metal ions. The composition of such synthetic zeolites can be controlled so that the type of cation can be selected. Such zeolites may have lesser amounts of aluminium than silica, and substantially no iron. The zeolites also may have no cadmium. Non-polar (siliceous) zeolites can be synthesized from aluminium-free silica sources or by dealumination of aluminium-containing zeolites. Dealumination can be performed by treating the zeolite with steam at elevated temperatures, typically greater than 500° C. (930° F.). This high temperature heat treatment can break the aluminium-oxygen bonds so that the aluminium atom is expelled from the zeolite framework. Zeolites can also have various pore size distributions, and the pore size can be adapted to help exclude or include molecules of selected sizes.

Activated carbon can be used for adsorption of organic substances and non-polar adsorbates. Activated carbon is one of the most widely used adsorbents because most of its chemical (e.g. surface groups) and physical properties (e.g. pore size distribution and surface area) can be tuned according to what is needed. Its usefulness also derives from its large micropore (and sometimes mesopore) volume and the resulting high surface area.

In one example of a pressure swing adsorption process, hydrogen gas is the least adsorbed component and all other impurities are removed from the hydrogen. Polar or polarizable compounds such as carbon dioxide and water are often easier to remove than non-polar ones such as methane and nitrogen. However, if the pressure swing adsorption unit is not operating optimally, carbon monoxide and nitrogen gas are typically the first impurities seen in the purified hydrogen stream because carbon monoxide and nitrogen typically have the next lowest adsorption rates.

For example, after removal of water and other readily condensed components, hydrogen can be recovered from the gaseous waste stream by passage through one or more pressure swing adsorption units to remove undesired components. The undesirable components can be adsorbed under pressures ranging from at least about 12 bar (absolute) pressure, or at least about 13 bar pressure, or at least about 14 bar pressure, or at least about 15 bar pressure. For example, undesired components can be adsorbed into pressure swing adsorption materials at about 12 bar to about 40 bar, or about 15 bar to about 20 bar absolute pressure. After passage through the pressure swing adsorption unit(s), the hydrogen can be at least 90% pure, or at least 95%, or at least 99%, or at least 99.9% pure. The undesired components can be desorbed from the pressure swing adsorption unit(s) so these units can be reused. Desorption of the undesired components can be effected by reducing the pressure to about 1 bar absolute pressure to about 10 bar absolute pressure.

Adsorptive materials useful for hydrogen recovery include zeolites that contain calcium oxide (CaO), alkali alumina silicates, and mixtures thereof. The aluminium content can be less than the silica content. While the zeolites can have some metals such as platinum and/or palladium, the zeolites typically have only small amounts of iron or substantially no iron or cadmium. For example, the zeolite can contain less than 1.0% by weight iron, or less than 0.7% by weight of iron, or less than 0.5% iron, or less than 0.3% by weight of iron, or less than 0.1% iron. Such zeolites can include a variety of pore sizes, such as pores with diameters of about 3 angstroms to about 7 angstroms, or about 4 angstroms to 5 angstroms. These zeolites can remove water, carbon dioxide, sulfur-containing contaminants and other components from a gas stream.

Examples of pressure swing adsorbent systems that can be adapted for use in the methods and systems described herein include those provided by UOP (Honeywell). For example, the pressure swing adsorbent can include zeolite materials such as those available from UOP. For example, at least two different materials can be employed to remove the different components in the gaseous waste stream. At least one type of adsorbent material can be employed to remove organic components such as residual HCN, methane and organonitriles. At least one other type of adsorbent materials can be used to remove other components such as nitrogen, carbon monoxide, carbon dioxide, and the like. Such materials can be used in a Polybed PSA System (see website at uop.com/processing-solutions/refining/hydrogen-management/). The UOP Polybed PSA System is a cyclical process in which the impurities in a hydrogen containing steam are adsorbed at high pressure and subsequently rejected at low pressure.

Gas mixtures can also be separated by selective diffusion through membranes. The gases can be concentrated, placed under pressure, or subjected to pressure gradients. Separation can occur via the differences in transport and thermodynamic partition or equilibrium properties of the mixture components in the membrane materials. For example, the distribution of pore sizes in the membrane can be adapted with consideration for the diameters of component molecules in a gaseous waste stream, so that separation is effected by molecular exclusion or molecular sieving. At much larger pore sizes, in which the pore diameters approach the mean free paths of the component molecules in a gaseous waste stream, Knudsen diffusion can occur and separation can be effected by molecular collision with pore walls. See, e.g., Knudsen, Ann Phys 28: 75 (1908); Gilron & Soffer, J. Membr Sci 209(2): 339-352 (2002); Zalc et al., Chem Eng Sci 59(14): 2947-60 (2004).

When at least a portion of the pores in the porous material are larger than the molecular diameters of key mixture components to be separated, but not large enough for significant Knudsen diffusion to occur, dense phase diffusion can occur. When pressure, temperature, and gas composition are such that certain components in the mixture can condense in the pores due to Kelvin or capillary condensation, these components can condense and diffuse through the pores as a liquid under a capillary pressure gradient, thus effecting a separation of the gas mixture. In some porous semipermeable membranes, a porous adsorptive material selectively adsorbs a significant portion of at least one of the primary components in the gaseous waste stream, the adsorbed components diffuse by surface flow in an adsorbed phase through the pores due to adsorbed phase concentration gradients created by pressure gradients across the membrane, and the diffusion product is thus enriched in at least one of the primary components. The presence of adsorbed primary components in the pores hinders the diffusion of less-strongly adsorbed or non-adsorbed secondary components, so that the non-diffused or non-absorbed portion is enriched in the secondary components. The predominant mechanism of this separation is that of adsorbed phase surface flow. Such a membrane can be operated at temperature above which or at pressures below which Kelvin or capillary condensation can occur for the gas mixtures of interest. Such membranes are therefore applied to the separation of non-condensable gas mixtures.

Table 1 lists the molecular diameters of various molecules that may be present in a gaseous waste stream. Such molecular diameters are defined herein as the kinetic diameter, σ, which is described in more detail by D. W. Breck, ZEOLITE MOLECULAR SIEVES, pages 633-645, and Table 8.14 at page 636, Kruger Publishing Co. (1984), the contents of which is incorporated herein by reference in its entirety.

TABLE 1

| Component | Molecular Diameter, σ, Angstroms |
|---|---|
| Helium | 2.6 |
| Hydrogen | 2.89 |
| Carbon Dioxide | 3.3 |
| Oxygen | 3.46 |
| Nitrogen | 3.64 |
| Carbon Monoxide | 3.76 |
| Methane | 3.8 |
| Ethylene | 3.9 |
| Propane | 4.3 |
| n-Butane | 4.3 |

Membranes can be used to filter put, adsorb or remove differently sized components from the gaseous waste stream. For example, one type of molecular sieve that can be used for absorbing water vapor is a 4 A molecular sieve, which has a pore size of 4 angstroms. Any molecule larger than 4 angstroms will not be able to be adsorbed. Adsorption by 4 A molecular sieves is generally better and more commonly used than some other types of molecular sieves or adsorbents because 4 A molecular sieves use little energy and have no significant detrimental effects on gaseous feedstreams. The 4 A molecular sieve can be obtained from a variety of suppliers, such as Delta Adsorbents (see, e.g., website at deltaadsorbents.com) or Texas Technologies Inc. (see, e.g., website at texastechnologies.com).

Another method by which undesired components can be removed from the gaseous waste stream is amine scrubbing. Amine scrubbing involves passage of the gaseous waste stream through aqueous solutions of various alkylamines to remove hydrogen sulfide (H₂S) and carbon dioxide (CO₂). Alkylamines that can be used include monoethanolamine, diethanolamine, methyldiethanolamine, diisopropylamine, amunoethoxythanol, and mixtures thereof. The concentration of the alkylamine can vary from about 5% to about 75%. However, different concentrations of the different alkylamines can be effective for removal of different waste components. While the Andrussow reaction can produce significant amounts of carbon dioxide and carbon monoxide, hydrogen sulfide will not be present in any significant amount. Thus, for removal of carbon dioxide and carbon monoxide, monoethanolamine can be employed at concentrations of about 25% to about 45%, or about 30% to about 35%, or at about 32%. When diethanolamine is used, a concentration of about 10% to about 30%, or about 20% to about 25% can be used for removing carbon dioxide and carbon monoxide. When methyldiethanolamine is employed, a concentration of about 25% to about 60%, or about 30 to about 55% can be used for removing carbon dioxide and carbon monoxide. When diglycolamine is used, a concentration of about 40% to about 60%, or about 45% to about 55%, or about 50% can be employed for removing carbon dioxide and carbon monoxide.

The gaseous waste stream can pass through a column or tank containing the amine scrubber solution, where the column or tank can be heated to temperatures of about 30° C. to about 60° C., or about 35° C. to about 50° C.

For hydrogen recovery, cryogenic purification typically involves condensing or adsorbing the undesired gaseous components away from the hydrogen by applying pressure and cooling the gaseous waste stream, An adsorbent such as activated carbon can be used to facilitate removal of waste. A series of columns or adsorption units can be used to obtain a hydrogen product with lower levels of contaminants.

To remove carbon monoxide from the gaseous waste stream a water gas shift reaction can be employed. When heated with a catalyst, water and carbon monoxide combine during the water shift reaction to generate carbon dioxide and hydrogen.

CO+H₂O→CO₂+H₂

The reaction is somewhat temperature sensitive and can involve two steps, a high temperature step and a lower temperature step. The higher temperature step can be performed at about 325° C. to about 375° C. (e.g., about 350° C.) using a catalyst that includes iron oxide promoted with chromium oxide, while the lower temperature step can be performed at about 180° C. to about 22° C., or about 190° C. to about 210° C. using a catalyst that includes copper on a mixed support of zinc oxide and aluminium oxide.

Combinations of steps can be employed to facilitate hydrogen recovery. For example, the gaseous waste stream can first be compressed, any liquids that condense in inter-stage coolers can be removed, the compressed gaseous waste stream can be filtered, and then the remaining gases can be fed into pressure swing adsorption unit(s). A water gas shift reaction can be employed to increase the yield of hydrogen. In addition to employing swings of pressure, the pressure swing adsorption units can be cooled to facilitate adsorption during high pressure phases and to more optimally sequester undesired components away from non-adsorbed hydrogen. A series of pressure swing adsorption units can be employed, with or without refrigeration elements to cool the adsorption materials.

While the recovered hydrogen need not be 100% pure, removal of at least the majority of the carbon dioxide, carbon monoxide and nitriles from the hydrogen is desirable to avoid side products and contaminants when the recovered hydrogen is used, for example, for hydrogenation reactions. For example, the processes and apparatuses described herein can produce a recovered hydrogen product from the gaseous waste stream, where the recovered hydrogen can be at least about 80% hydrogen, or at least about 85% hydrogen, or at least about 90% hydrogen, or at least about 91% pure, or at least about 92% pure, or at least about 93% pure, or at least about 94% pure, or at least about 95% pure, or at least about 96% pure, or at least about 97% pure, or at least about 98% pure, or at least about 99% pure hydrogen. Some trace amounts of methane or nitrogen can be acceptable in the hydrogen product.

The recovered hydrogen can be used in hydrogenation reactions (e.g., to hydrogenate saturated alkenes, alkynes or hydrocarbons with saturated bonds). Alternatively, the recovered hydrogen can be used for heat or energy production. For example, the recovered hydrogen can be burned in a boiler to generate steam that is useful as heat. The recovered hydrogen can also be used to generate electricity, for example, in a co-generation system that generates steam and electricity.

### Hydrogen Recovery System

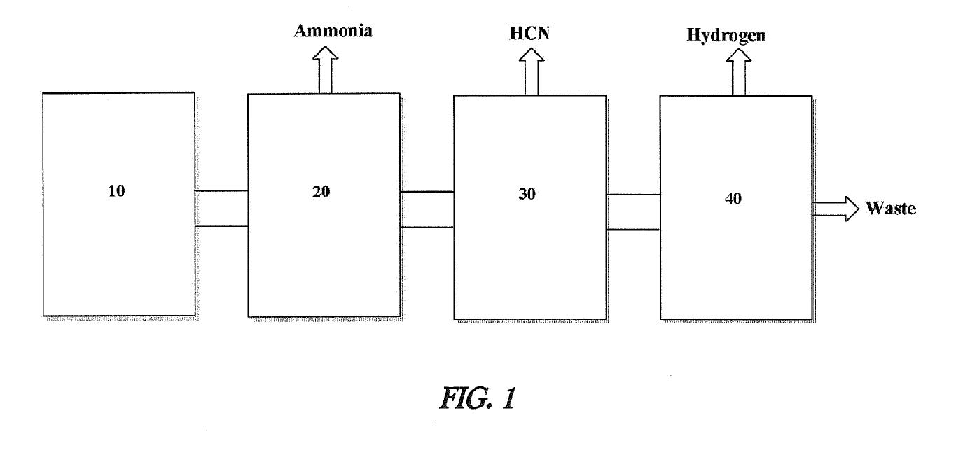

The methods described herein can be performed in a hydrogen recovery system that is operably linked to an Andrussow reaction and HCN recovery train. The Andrussow reaction can be performed in an Andrussow reactor 10 to yield a product stream 15 that contains HCN along with ammonia and waste as illustrated in FIG. 1 and described in more detail above. The ammonia in the product stream 15 can be removed in an ammonia stripper unit 20 to generate a semi-purified product stream 25 that contains HCN and waste. HCN can be recovered from the semi-purified product stream 25 by treatment in a HCN absorber unit 30 to yield HCN product and a gaseous waste stream 35. Hydrogen can be recovered from the gaseous waste stream 35 in a hydrogen recovery system 40. The gaseous waste stream 35 can travel through a moisture removal unit such as a condenser (not illustrate) prior to entry into gaseous waste stream 35.

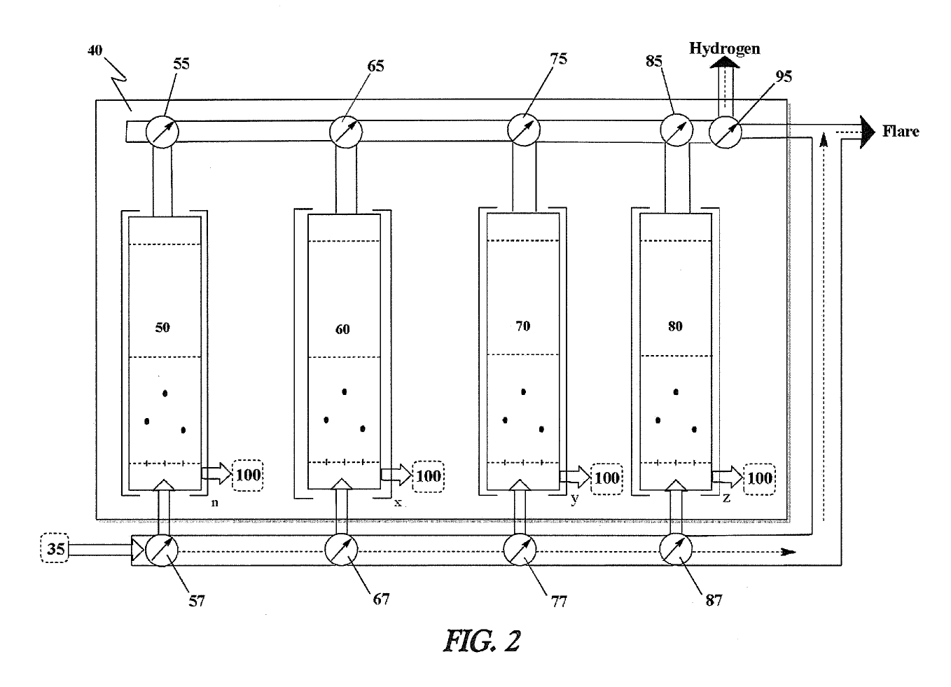

The hydrogen recovery system 40 can include any of the components and materials described herein. For example, as illustrated in FIG. 2, a gaseous waste stream 35 can enter a hydrogen recovery system 40 which can include one or more first units 50, one or more second units 60, one or more third units 70, and/or one or more fourth units 80, where the variables n, x, y and z are integers each separately having a value from 0 to 8. Thus, there can be 0 to 8 first units 50, 0 to 8 second units 60, 0 to 8 third units 70, and/or 0 to 8 fourth units 80.

The 50, 60, 70 and 80 units can perform similar functions and can have similar materials within them. For example, each of the 50, 60, 70 and 80 units can have section that includes carbon adsorption materials and a separate section that includes zeolites that can absorb gaseous components such as oxygen (O₂), nitrogen (N₂), and/or argon. For example, a section that includes carbon adsorption materials can be at the bottom of the 50, 60, 70 and 80 units, while a section that includes zeolites can be at the top of the 50, 60, 70 and 80 units.

As also illustrated FIG. 2, the hydrogen recovery system can include one or more valves and one or more analysers. For example, hydrogen recovery system can include valves 57, 67, 77, and 87 that can control entry waste gas stream into one or more of the 50, 60, 70 and 80 units. The waste gas stream can pass through one or more of the 50, 60, 70 and 80 units and out through one or more analyzers 55, 65, 75 and 85 that can detect the composition of effluent from the respective 50, 60, 70 and 80 units. The 50, 60, 70 and 80 units can be used in parallel or in series. For example, the valve 57 can allow the gaseous waste stream to flow into the first unit 50 where impurities are removed from the waste stream. The valve 57 can have an analyser operably linked to it that only allows the gaseous waste stream to flow into the first unit 50 when the gaseous waste stream has sufficient hydrogen to make recovery of the hydrogen economically worthwhile. When the gaseous waste stream flows into the first unit 50 waste is adsorbed by the materials in the first unit 50, and hydrogen passes from the top of the first unit 50 through an analyser 55. The analyser 55 analyzes the composition of the hydrogen emerging from the first unit 50. When the composition of the hydrogen emerging from the first unit 50 is above or equal to a set value, or the composition of the hydrogen emerging from the first unit 50 contains less than a set value of impurities, the gaseous waste stream can continue to flow through the first unit 50. However, when the purity of the hydrogen emerging from the first unit 50 drops below a set value, or when the composition of the hydrogen emerging from the first unit 50 contains more than a set value of impurities, the analyser 55 signals the value 57 to stop flow into the first unit 50. The analyser 55 can also signal the value 67 to allow flow of the waste stream into the second unit 60, while also signalling closure of a unit diverter operably linked with the analyser 55.

Closure of a unit diverter operably linked with the analyser 55 causes the gaseous waste stream to bypass the first unit 50 and flows through the valve 67 and into the second unit 60. Wastes are removed from the waste stream as it passes through the second unit 60. Hydrogen passes from the top of the second unit 60 and through an analyser 65, which has a function similar to the analyser 55. As described above for the analyser 55, the analyser 65 continues to allow waste gas to flow into the second unit 60 so long as the hydrogen flowing through the analyser 65 is at least as pure as a set value, or the level of impurities are no greater than a set value. When the hydrogen flowing through the analyser 65 is no longer as pure as a set value, or the level of impurities are the same or greater than a set value, the analyser 65 signals closure of the valve 67 so that the waste stream bypasses the second unit 60. The analyser 65 can also signal the valve 77 to allow flow of the waste gas into the third unit 70, while closing a unit diverter operably associated with the analyser 65. The analyzers 75 and 85 have the same functions as the analyzers 55 and 65. Similarly, the valves 77 and 87 have the same function as the valves 57 and 67.

The gaseous waste stream can therefore flow through first through one or more first units 50, so that hydrogen is recovered first from these first units 50. Second, the gaseous waste stream can flow through one or more second units 60, so that hydrogen is recovered and collected second from these second units 60. While hydrogen is recovered and/or collected from these second units 60, the first units 50 can be purged of adsorbed waste, and the adsorbent materials regenerated for further use in removing waste from the hydrogen-containing waste gases. For example, the first units 50 can be heated and purged with hydrogen so that the adsorbed waste is removed from the first unit as tail gas 100. The gaseous waste stream can flow through one or more second units 60, so that hydrogen is collected second from these second units 60. When the adsorbent materials in the second units 60. Need regenerating, the gaseous waste stream can flow through one or more third units 70, and so one through to the one or more fourth units 80. The tail gas 100 can be treated as needed or sent to flare.

One or more analysers 95 can monitor the oxygen concentration of the final hydrogen product. Such an oxygen concentration analyser can incorporate or be operably linked to an effluent diverter to channel hydrogen containing gas to flare if the oxygen content of the hydrogen containing gas is higher than a first oxygen content set point. For example, the first oxygen content set point can be about 3 vol/vol %, or about 2 vol/vol %, or about 1% vol/vol, or about 0.5% vol/vol oxygen.

The analyser 95 can include or be operably linked to an initiator for an interlock that is initiated when a second oxygen set point is detected. Such an interlock can close the flow valves to the operating flare. Such an interlock can also shut down the first unit(s) 50, the second unit(s) 60, and the third unit(s) 70 to divert the hydrogen containing gas to a container. For example, the second oxygen content set point can be about 5 vol/vol %, or about 3% vol/vol, or about 2% vol/vol oxygen. To ensure that the initiator is properly initiated, the initiator can be activated only when two or three analysers 95 detect that the hydrogen containing gas has an oxygen concentration of at least the second oxygen content set point.

The materials and functioning of such units are further described herein, for example, in the foregoing section.

The following non-limiting Examples illustrate some procedures for recovering hydrogen from a gaseous waste stream from an Andrussow process for producing hydrogen cyanide.

### Example 1

### Comparison Air and Oxygen Andrussow Process Waste Gas Compositions

This Example illustrates that an Andrussow process that uses a highly enriched source of oxygen generally produces a waste stream with higher hydrogen content than one that employs air as an oxygen source.

A 4 inch internal diameter stainless steel reactor with ceramic insulation lining inside is used for a pilot scale test. Forty sheets of 90 wt % Pt/10 wt % Rh 40 mesh gauze from Johnson Matthey (USA) are loaded as the catalyst bed. Perforated alumina tile is used for catalyst sheet support. The total flow rate is set at 2532 SCFH (standard cubic foot per hour). Hydrogen cyanide is produced via two separate Andrussow processes. One process is an oxygen Andrussow process that employs a gaseous reaction mixture that includes 35 vol % methane, 38 vol % ammonia and 27 vol % substantially pure oxygen. A second process is an air Andrussow process employs about 17 vol % methane, 19 vol % ammonia and 64 vol % air. The platinum-containing catalyst is used for both processes.

Ammonia is separately removed from each of the product streams in a process involving absorption into an ammonium phosphate stream. Hydrogen cyanide is then removed from the ammonia-depleted product stream in a process involving acidified water, thereby separately generating a hydrogen cyanide product and a gaseous waste stream for each of the processes.

The composition of the gaseous waste streams from the oxygen and air processes, after ammonia and HCN removal are shown below in Table 2.

TABLE 2
Gaseous Waste Stream Composition

| Simulation | | |
|---|---|---|
| results | O₂ | Air |
| Component | % (v/v) | % (v/v) |
| H₂ | 78.78 | 16.74 |
| N₂ | 5.43 | 76.33 |
| CO | 11.18 | 4.43 |
| Ar | 0.17 | 0.48 |
| O₂ | 0.09 | 0.00 |
| CH₄ | 1.03 | 0.83 |
| CO₂ | 0.99 | 0.29 |
| NH₃ | 0.00 | 0.00 |
| HCN | 0.13 | 0.05 |
| acrylonitrile | 0.00 | 0.00 |
| acetonitrile | 0.05 | 0.01 |
| propionitrile | 0.00 | 0.00 |
| H₂O | 2.14 | 0.91 |
| H₂SO₄ | 0.00 | 0.00 |
| H₂PO₄ | 0.00 | 0.00 |
| Total | 100 | 100 |

As illustrated, an Andrussow process that employs highly enriched oxygen as a source of the oxygen-containing feedstream generates significantly more hydrogen than an Andrussow process that employs air as a source of the oxygen-containing feedstream.

### Example 2

### Hydrogen Content in the Gaseous Waste Stream

This Example illustrates how the hydrogen content of the gaseous waste stream varies in Andrussow processes using reactant oxygen-containing feedstreams with different amounts of oxygen.

Hydrogen cyanide is produced via a series of separate Andrussow processes performed as described for Example 1. However, each process is performed using a different reactant oxygen-containing feedstream, where the content of oxygen in the feedstream is varied between about 20.9% vol/vol to about 100% vol/vol oxygen, as shown in Table 3.

Ammonia is separately removed from each of the product streams in a process involving absorption into an ammonium phosphate stream. Hydrogen cyanide is then removed from the ammonia-depleted product stream in a process involving acidified water, thereby separately generating a hydrogen cyanide product and a gaseous waste stream for each of the processes.

The composition of the gaseous waste streams from Andrussow processes run with oxygen-containing feedstreams having different oxygen contents are shown below in Table 3.

TABLE 3
Waste Gas Stream BTU Value as Oxygen Percentage Increases

| Reactant Feed | Waste Gas | | | |
|---|---|---|---|---|
| stream | Stream¹ | Waste Gas | Waste Gas | Valuable as |
| (Percent | (Percent | Stream | Stream | Fuel² |
| vol/vol O₂) | vol/vol H₂) | (Percent CO) | BTU/SCF) | (Yes/No) |
| Air (20.95%) | 16.7 | 4.43 | 67.6 | No |
| 25% Oxygen | 21.2 | 5.28 | 83.2 | No |
| 35% Oxygen | 32.3 | 7.11 | 120.3 | No |
| 45% Oxygen | 42.6 | 8.53 | 153.3 | No |
| 55% Oxygen | 51.8 | 9.56 | 181.5 | No |
| 65% Oxygen | 59.6 | 10.3 | 205.0 | Yes |
| 75% Oxygen | 66.3 | 10.7 | 224.4 | Yes |
| 80% Oxygen | 69.2 | 10.9 | 232.7 | Yes |
| 85% Oxygen | 71.9 | 11.0 | 240.3 | Yes |
| 90% Oxygen | 74.4 | 11.1 | 247.1 | Yes |
| 95% Oxygen | 76.7 | 11.2 | 253.3 | Yes |
| Pure Oxygen | 78.8 | 11.2 | 258.9 | Yes |

¹Waste gas stream refers to the % hydrogen in the waste stream after ammonia and HCN removal.
²“Valuable” refers to whether the waste gas stream is capable of being used as a fuel gas (e.g., combustion) without the addition of natural gas.

### Example 3

### Recovery of Hydrogen by Pressure Swing Adsorption

This Example can illustrate how hydrogen can be recovered from an Andrussow product stream using a pressure swing adsorption apparatus.

Hydrogen cyanide is produced via an Andrussow process using a gaseous reaction mixture that includes 35 vol % methane, 38 vol % ammonia, and 27 vol % substantially pure oxygen in the presence of a platinum catalyst. A 4 inch internal diameter stainless steel reactor with ceramic insulation lining inside is used for a pilot scale test. Forty sheets of 90 wt % Pt/10 wt % Rh 40 mesh gauze from Johnson Matthey (USA) are loaded as the catalyst bed. Perforated alumina tile is used for catalyst sheet support. The total flow rate is set at 2532 SCFH (standard cubic foot per hour). The gaseous product stream from the reactor contains 16.6 vol % hydrogen cyanide, 6.1 vol % unreacted ammonia, 34.5 vol % hydrogen, 6.0 vol % CO and 33.6 vol % H₂O.

Ammonia is removed from the product stream in a process involving absorption into an ammonium phosphate stream. Hydrogen cyanide is then removed from the ammonia-depleted product stream in a process involving acidified water, thereby generating the hydrogen cyanide product and a gaseous waste stream.

The gaseous waste stream is dehumidified by condensation to reduce the moisture content. Other impurities such as trace amounts of acid can also be removed from the dehumidified waste gases by condensation. The dehumidified waste stream is then compressed within a pressure swing adsorption apparatus containing a zeolite or molecular sieve adsorbent. A chamber in the apparatus is pressurized to about 20 bar, allowing selective adsorption of the impurities.

The hydrogen removed from the chamber produced has less than approximately 5 vol % impurities, mainly nitrogen (N₂) and methane (CH₄).

The chamber is depressurized after hydrogen recovery to remove adsorbed impurities.

All patents and publications referenced or mentioned herein are indicative of the levels of skill of those skilled in the art to which the invention pertains, and each such referenced patent or publication is hereby specifically incorporated by reference to the same extent as if it had been incorporated by reference in its entirety individually or set forth herein in its entirety. Applicants reserve the right to physically incorporate into this specification any and all materials and information from any such cited patents or publications.

The specific methods, devices and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention.

The invention illustratively described herein suitably may be practiced in the absence of any element or elements, or limitation or limitations, which is not specifically disclosed herein as essential. The methods and processes illustratively described herein suitably may be practiced in differing orders of steps, and the methods and processes are not necessarily restricted to the orders of steps indicated herein or in the claims.

As used herein and in the appended claims, the singular fortes “a,” “an,” and “the” include plural reference unless the context clearly dictates otherwise. Thus, for example, a reference to “a reactor” or “a dehumidifier” or “a feedstream” includes a plurality of such reactors, dehumidifiers or feedstreams (for example, a series of reactors, dehumidifiers or feedstreams), and so forth. In this document, the term “or” is used to refer to a nonexclusive or, such that “A or B” includes “A but not B,” “B but not A,” and “A and B,” unless otherwise indicated.

Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims and statements of the invention.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein. In addition, where features or aspects of the invention are described in terms of Markush groups, those skilled in the art will recognize that the invention is also thereby described in terms of any individual member or subgroup of members of the Markush group.

The following statements describe some of the elements or features of the invention. Because this application is a provisional application, these statements may become changed upon preparation and filing of a nonprovisional application. Such changes are not intended to affect the scope of equivalents according to the claims issuing from the nonprovisional application, if such changes occur. According to 35 U.S.C. §111(b), claims are not required for a provisional application. Consequently, the statements of the invention cannot be interpreted to be claims pursuant to 35 U.S.C. §112.

Statements:

In the following statements, the percentages are % vol/vol unless otherwise indicated.

1. A method of recovering hydrogen from a hydrogen cyanide product stream, comprising:

(a) removing ammonia from the product stream to generate a semi-purified product stream;

(b) removing hydrogen cyanide from the semi-purified product stream to yield purified hydrogen cyanide product and a gaseous waste stream; and

(c) removing components from the gaseous waste stream to generate recovered hydrogen;

wherein the gaseous waste stream contains at least about 40% hydrogen.

2. A method of recovering hydrogen from a gaseous waste stream of an Andrussow process comprising:

(a) adjusting a reaction mixture comprising methane, ammonia and oxygen to provide the reaction mixture with sufficient oxygen to generate a gaseous waste stream that has at least 40% hydrogen after removal of ammonia and recovery of hydrogen cyanide; and

(b) removing components from the gaseous waste stream to generate recovered hydrogen.

3. The method of statement 1 or 2, wherein the product stream comprises species selected from the group consisting of HCN, ammonia, H₂, CO, N₂, H₂O, CO₂, CH₄, one or more organonitriles and combinations thereof.

4. The method of any of statements 1-3, wherein the gaseous waste stream comprises no more than about 1.5% HCN.

5. The method of statement 1, wherein the gaseous waste stream comprises at least 20% hydrogen, or at least, 30% hydrogen, or at least 40% hydrogen, or at least, 50% hydrogen, or at least 60% hydrogen, or at least, 65% hydrogen, or at least 70% hydrogen.

6. The method of any of statements 1-5, wherein the gaseous waste stream comprises about 70% to about 80% hydrogen.

7. The method of any of statements 1-6, wherein the gaseous waste stream comprises about 73% to about 78% hydrogen.

8. The method of any of statements 1-7, wherein the gaseous waste stream comprises at least 5% carbon monoxide, or at least 10% carbon monoxide.

9. The method of any of statements 1-8, wherein the gaseous waste stream comprises about 10% to about 15% carbon monoxide.

10. The method of any of statements 1-9, wherein the gaseous waste stream comprises at least 2% nitrogen, or at least 3% nitrogen.

11. The method of any of statements 1-10, wherein the gaseous waste stream comprises about 2% to about 6% nitrogen.

12. The method of any of statements 1, 3-10 or 11, wherein the gaseous waste stream comprises about 80% to about 93% nitrogen.

13. The method of any of statements 1-12, wherein the gaseous waste stream comprises at least 0.2% methane, or at least 0.3% methane.

14. The method of any of statements 1-13, wherein the gaseous waste stream comprises about 0.2% methane to about 2.0% methane.

15. The method of any of statements 1-14, wherein the gaseous waste stream comprises about 0.4% methane to about 1.8% methane.

16. The method of any of statements 1-15, wherein the gaseous waste stream comprises about 0.2% carbon dioxide to about 2.0% carbon dioxide.

17. The method of any of statements 1-16, wherein the gaseous waste stream comprises about 0.3% carbon dioxide to about 1.8% carbon dioxide.

18. The method of any of statements 1-17, wherein the gaseous waste stream comprises about 0.001% organonitriles to about 0.05% organonitriles.

19. The method of any of statements 1-18, wherein the gaseous waste stream comprises one or more organonitriles selected from the group consisting of acetonitrile, acrylonitrile, propionitrile and combinations thereof.

20. The method of any of statements 1-19, wherein the gaseous waste stream comprises about 72% hydrogen to about 78% hydrogen, about 12% carbon monoxide to about 15% carbon monoxide, about 0.7% carbon dioxide to about 1.5% carbon dioxide, about 3% nitrogen to about 5% nitrogen, about 1% methane to about 2.0% methane, about 0.01% organonitriles to about 0.1% organonitriles, about 0.01% HCN to about 0.05% HCN, about 3% water to about 5% water, and combinations thereof.

21. The method of any of statements 1-20, wherein the gaseous waste stream comprises about 1% hydrogen to about 2% hydrogen, about 3% carbon monoxide to about 8% carbon monoxide, about 0.2% carbon dioxide to about 0.8% carbon dioxide, about 80% nitrogen to about 95% nitrogen, about 0.1% methane to about 1.0% methane, about 0.01% organonitriles to about 0.5% organonitriles, about 0.05% HCN to about 0.5% HCN, about 0.2% water to about 1.5% water, and combinations thereof.

22. The method of any of statements 1-21, wherein removing components from the gaseous waste stream comprises removing carbon monoxide, nitrogen, water, carbon dioxide, methane, one or more organonitriles, or a combination thereof.

23. The method of any of statements 1-22, wherein removing components from the gaseous waste stream comprises condensation, amine scrubbing, pressure swing adsorption, cryogenic purification, or a combination thereof.

24. The method of any of statements 1-23, wherein removing components from the gaseous waste stream comprises passing the gaseous waste stream through a hydrogen-permeable membrane, a palladium membrane, a hydrocarbon absorption medium, a gas expansion unit, a water gas shift chemical converter unit, or a combination thereof.

25. The method of any of statements 1-24, wherein removing components from the gaseous waste stream comprises passing the gaseous waste stream through an adsorbent to remove undesired components from the gaseous waste stream.

26. The method of any of statements 1-25, wherein removing components from the gaseous waste stream comprises passing the gaseous waste stream through an adsorbent, and wherein the adsorbent comprises a silica gel, activated carbon, zeolite, molecular sieve, or a combination thereof.

27. The method of any of statements 1-26, wherein removing components from the gaseous waste stream comprises passing the gaseous waste stream through a water gas shift conversion unit to convert carbon monoxide and water to carbon dioxide and hydrogen.

28. The method of statement 27, wherein the water gas shift conversion generates up to about 20% more hydrogen, or up to about 15% more hydrogen, or up to about 13% more hydrogen than would be produced if the gaseous waste stream was not passed through the water gas shift conversion unit.

29. The method of any of statements 1-28, wherein removing components from the gaseous waste stream comprises passing the gaseous waste stream through one or more condensation units.

30. The method of statement 29, wherein the one or more condensation units remove condensable components from the gaseous waste stream such water vapor, and/or aqueous solutes that can condense with water.

31. The method of any of statements 1-30, wherein removing components from the gaseous waste stream comprises passing the gaseous waste stream through one or more units, each unit comprising a section containing carbon adsorption materials and a section containing zeolites.

32. The system of any of statements 1-31, wherein removing components from the gaseous waste stream comprises passing the gaseous waste stream through 0 to 8 first units, 0 to 8 second units, 0-8 third units, 0-8 fourth units, and combinations thereof; each unit comprising a section containing carbon adsorption materials and a section containing zeolites wherein the hydrogen recovery system comprises.

33. The method of statement 32, wherein the carbon adsorption materials remove carbon-containing components.

34. The method of statement 33, wherein the carbon-containing components comprise carbon dioxide, carbon monoxide, hydrogen cyanide, or combinations thereof.

35. The method of any of statements 31-34, wherein the zeolites remove oxygen (O₂), nitrogen (N₂), argon and combinations thereof.

36. The method of any of statements 1-35, wherein the recovered hydrogen is at least about 90% pure, or at least about 91% pure, or at least about 92% pure, or at least about 93% pure, or at least about 94% pure, or at least about 95% pure, or at least about 96% pure, or at least about 97% pure, or at least about 98% pure, or at least about 99% pure hydrogen.

37. The method of any of claims 1-36, wherein the hydrogen cyanide is generated in a reaction of methane, ammonia and oxygen.

38. The method of claim 37, wherein the methane is supplied as a natural gas.

39. The method of claim 37, wherein the methane is supplied as substantially pure methane.

40. The method of any of claims 1-39, wherein the hydrogen cyanide is generated in a reaction of methane, ammonia and oxygen, and wherein the oxygen is supplied as air, molecular oxygen, a mixture of air and oxygen, or a mixture of oxygen and nitrogen.

41. The method of any of claims 1-40, wherein the recovered hydrogen is employed for hydrogenation.

42. The method of any of claims 1-41, wherein the recovered hydrogen is employed for hydrogenation of adiponitrile.

43. The method of any of claims 1-42, wherein the recovered hydrogen is employed for hydrogenation of adiponitrile to generate hexamethylenediamine.

44. The method of any of claims 1-40, wherein the recovered hydrogen is employed for heat or energy generation.

45. The method of any of claims 1-44, wherein the method recovers at least about 60%, or at least about 70%, or at least about 80%, or at least about 90% of the hydrogen in the gaseous waste stream.

46. A system comprising:

(a) a reactor configured for producing hydrogen cyanide from a reaction mixture comprising methane, ammonia and oxygen in the presence of a platinum catalyst, wherein the reactor produces a gaseous product stream comprising the hydrogen cyanide; and

(b) a hydrogen recovery system configured to recover hydrogen from a gaseous waste stream produced after ammonia and the hydrogen cyanide have been substantially removed from the gaseous product stream.

47. The system of statement 46, further comprising an ammonia stripper unit to remove ammonia from the gaseous product stream to generate a semi-purified product stream that contains HCN and waste.

48. The system of 46 or 47, further comprising an HCN absorber unit to yield HCN product and the gaseous waste stream.

49. The system of any of statements 46-48, wherein the hydrogen recovery system comprises one or more first units, one or more second units, one or more third units, or one or more fourth units.

50. The system of any of statements 46-49 wherein the hydrogen recovery system comprises 0 to 8 first units, 0 to 8 second units, 0-8 third units, 0-8 fourth units, and combinations thereof

51. The system of any of statements 46-50, wherein the hydrogen recovery system comprises one or more first units, one or more second units, one or more third units, or one or more fourth units, and wherein each of the first units, the second units, the third units, and the fourth units comprise materials selected from the group consisting of carbon adsorption materials, zeolites, and combinations thereof.

52. The system of statement 51, wherein each of the first units, the second units, the third units, and the fourth units comprise a section containing carbon adsorption materials and a section containing zeolites.

53. The system of statement 51 or 52, wherein the carbon adsorption materials adsorb carbon-containing components from the gaseous waste stream.

54. The system of any of statements 51-53, wherein the carbon adsorption materials absorb carbon dioxide, carbon monoxide, methane, residual hydrogen cyanide, and combinations thereof.

55. The system of any of statements 52-54, wherein the zeolites can adsorb oxygen (O₂), nitrogen (N₂), argon and combinations thereof

56. The system of any of statements 46-55, wherein the system comprises one or more condensation units configured to remove moisture from the gaseous waste stream.

57. The system of statement 56, wherein the one or more condensation units can remove condensable components from the gaseous waste stream such water vapor, and, optionally, aqueous solutes (if present) that can condense with water.

58. The system of any of statements 46-57, further comprising an effluent analyser for detecting the composition of effluent emerging from the hydrogen recovery system.

59. The system of any of statements 46-58, wherein the hydrogen recovery system further comprises one or more intake valves operably linked to one or more first units, one or more second units, one or more third units, or one or more fourth units, wherein the gaseous waste can flow into a unit when the intake valve operably linked thereto is opened.

60. The system of any of statements 46-59, wherein the hydrogen recovery system further comprises one or more unit analyzers operably linked to one or more first units, one or more second units, one or more third units, or one or more fourth unit for detecting or quantifying levels of hydrogen or waste components emerging from those one or more units.

61. The system of statement 60, wherein one or more of the unit analysers further comprises one or more unit diverters to close one or more outlet valves operably linked to one or more first units, one or more second units, one or more third units, or one or more fourth units.

62. The system of statement 60 or 61, wherein one or more unit diverters is optionally linked to one or more unit analyzers.

63. The system of any of statements 49-62, wherein one or more of the first units, second units, third units or fourth units is regenerated while one or more of the first units, second units, third units or fourth units recovers hydrogen from the gaseous waste stream.

64. The system of any statements 46-63, further comprising a hydrogen detector operably linked to a waste stream diverter for diverting the gaseous product stream away from the hydrogen recovery unit when the hydrogen detector detects that hydrogen levels in the gaseous product stream are unacceptably low for hydrogen recovery.

65. The system of statement 64, wherein the hydrogen levels in the gaseous product stream are unacceptably low for hydrogen recovery when the hydrogen levels are less than 20%, or less than 25%, or less than 30%, or less than 40%, or less than 50%.

66. The system of any statements 46-65, further comprising one or more oxygen detectors for monitoring an oxygen concentration in effluent from the hydrogen recovery system.

67. The system of statement 66, wherein the one or more of the oxygen detectors initiates diversion of the effluent via one or more effluent diverters when an oxygen concentration in the effluent is equal to or greater than a first oxygen content set point.

68. The system of statement 67, wherein diversion of the effluent is initiated when at least two of the oxygen detectors detect that the oxygen content of the effluent is higher than the first oxygen content set point.

69. The system of statement 67 or 68, wherein the one or more oxygen detectors initiates diversion of the effluent to flare when an oxygen concentration in the effluent is equal to or greater than a first oxygen content set point.

70. The system of statement 66-68, wherein the one or more oxygen detectors initiates diversion of the effluent via one or more effluent diverters into one or more of the first units, one or more of the second units, one or more of the third units, or one or more of the fourth units when an oxygen concentration in the effluent is equal to or greater than a first oxygen content set point.

71. The system of any of statements 67-70, wherein the first oxygen content set point is about 1.5 vol/vol %, or about 1% vol/vol, or about 0.5% vol/vol oxygen.

72. The system of any of statements 46-71, further comprising an interlock that can be initiated when a second oxygen set point is detected by one or more oxygen detectors that monitor an oxygen concentration in effluent from the hydrogen recovery system.

73. The system of any of statements 46-72, further comprising an interlock that can be initiated when a second oxygen set point is detected by at least two oxygen detectors that monitor an oxygen concentration in effluent from the hydrogen recovery system.

74. The system of statement 72 or 73, wherein the interlock can shut down one or more of the first units, one or more of the second units, one or more of the third units, one or more of the fourth units, or a combination thereof in the hydrogen recovery system.

75. The system of any of statements 72-74, wherein the interlock can shut down each of the first units, the second units, the third units, and the fourth units.

76. The system of any of statements 46-75, further comprising an interlock that can close flow valves to an energy generation unit operably linked to the hydrogen recovery unit.

77. The system of any of statements 46-76, further comprising an interlock that can divert the hydrogen-containing effluent from the hydrogen recovery system into one or more containers.

78. The system of any of statements 46-77, further comprising an interlock that can divert the hydrogen-containing effluent from the hydrogen recovery system to flare.

79. The system of any of statements 72-78, wherein the second oxygen content set point is about 4 vol/vol %, or about 3% vol/vol, or about 2% vol/vol oxygen.

80. The system of any of statements 46-79, configured to recover at least about 60%, or at least about 70%, or at least about 80%, or at least about 90% of the hydrogen in the gaseous waste stream.

81. The system of any of statements 46-80, configured to perform any of the methods of any of statements 1-45.

1. A method of recovering hydrogen from a gaseous waste stream of an Andrussow process comprising:
(a) adjusting a reaction mixture comprising methane, ammonia and oxygen to provide the reaction mixture with sufficient oxygen to generate a gaseous waste stream that has at least 40% hydrogen after removal of ammonia and recovery of hydrogen cyanide; and
(b) removing components from the gaseous waste stream to generate recovered hydrogen.

2. The method of claim 1, wherein the sufficient oxygen is supplied as an oxygen-containing feedstream comprising at least 40% oxygen, or at least 45% oxygen.

3. The method of claim 1, wherein the gaseous waste stream comprises about 40% hydrogen to about 78% hydrogen, about 12% carbon monoxide to about 15% carbon monoxide, about 0.7% carbon dioxide to about 1.5% carbon dioxide, about 3% nitrogen to about 5% nitrogen, about 1% methane to about 2.0% methane, about 0.01% organonitriles to about 0.1% organonitriles, about 0.01% HCN to about 0.05% HCN, about 3% water to about 5% water, and combinations thereof.

4. The method of claim 1, wherein the gaseous waste stream comprises less than about 50% nitrogen.

5. The method of claim 1, wherein removing components from the gaseous waste stream comprises removing carbon monoxide, nitrogen, water, carbon dioxide, methane, one or more organonitriles, or a combination thereof.

6. The method of claim 1, wherein removing components from the gaseous waste stream comprises passing the gaseous waste stream through one or more condensation units.

7. The method of claim 1, wherein removing components from the gaseous waste stream comprises condensation, amine scrubbing, pressure swing adsorption, cryogenic purification, passage of the gaseous waste stream through a hydrogen-permeable membrane, passage of the gaseous waste stream through a palladium membrane, passage of the gaseous waste stream through a hydrocarbon absorption medium, passage of the gaseous waste stream through a gas expansion unit, passage of the gaseous waste stream through a water gas shift chemical converter unit, or a combination thereof.

8. The method of claim 1, wherein removing components from the gaseous waste stream comprises passing the gaseous waste stream through an adsorbent, and wherein the adsorbent comprises a silica gel, activated carbon, zeolite, molecular sieve, or a combination thereof.

9. The method of claim 1, wherein removing components from the gaseous waste stream comprises passing the gaseous waste stream through a water gas shift conversion unit to convert carbon monoxide and water to carbon dioxide and hydrogen.

10. The method of claim 1, wherein removing components from the gaseous waste stream comprises passing the gaseous waste stream through one or more units, each unit comprising a section containing carbon adsorption materials and a section containing zeolites.

11. The method of claim 1, wherein the recovered hydrogen is at least about 90% pure, or at least about 91% pure, or at least about 92% pure, or at least about 93% pure, or at least about 94% pure, or at least about 95% pure, or at least about 96% pure, or at least about 97% pure, or at least about 98% pure, or at least about 99% pure hydrogen.

12. The method of claim 1, wherein the hydrogen cyanide is generated in a reaction of methane, ammonia and oxygen.

13. The method of claim 1, wherein the recovered hydrogen is employed for hydrogenation, or for heat or energy generation.

14.-33. (canceled)
